(19) United States
(12) Patent Application Publication
(10) Pub. No.: US 2012/0113896 A1
(43) Pub. Date: May 10, 2012

(54) Skip Ahead Routing in Wireless Ad Hoc Networks

(75) Inventor: Mark Karol, Fair Haven, NJ (US)

(73) Assignee: Telcordia Technologies, Inc., Piscataway, NJ (US)

(21) Appl. No.: 13/237,513

(22) Filed: Sep. 20, 2011

Related U.S. Application Data
(60) Provisional application No. 61/411,980, filed on Nov. 10, 2010.

(51) Int. Cl. H04W 4/00

(52) U.S. Cl. 370/328

(57) ABSTRACT

A wireless ad hoc network may be composed of several nodes that are coupled by communication links and configured dynamically. As the packet is transmitted from one node to the next node or hop in a predetermined route, a neighboring node, within the same transmission range, may hear the broadcasted transmission. If the neighboring node determines that a future hop on the route includes the neighboring node, the neighboring node may receive the packet at that time thereby skipping one or more hops along the route. The neighboring node may then forward the packet to the next node in the route.

This application claims the benefit of U.S. Provisional Application 61/411,980, filed Nov. 10, 2010, incorporated herein in its entirety.

### BACKGROUND

1. Field of the Invention

The present invention relates generally to the field of communication networks, and more particularly to routing in ad hoc communication networks.

2. Description of the Related Art

An ad hoc network is a network of nodes connected through shared wireless communication links. The ad hoc network does not have an existing infrastructure, rather its structure is dynamically created as the nodes connect and disconnect to different links frequently. Typically, these networks are used in applications where there is a need to exchange information in a real-time, dynamically changing, and critical situation, such as in a military or disaster recovery environments.

The nodes in an ad hoc network have limited transmission range due to the radio power spectrum of the wireless communication links. This causes transmissions to distant nodes to take multiple hops (“multi-hops”) to travel from a source node to a destination node. A route may include multiple hops through multiple links and nodes in the network. As the network becomes larger, the network may experience problems in bandwidth degradation and network latency caused by the multi-hops. As such, routing in an ad hoc network is a key factor to improving the performance of a wireless ad hoc network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A wireless ad hoc network may be used to transmit packets from a source node to a destination node by making multiple hops within the network in accordance with a predetermined route. As the packet is transmitted from one node to the next, a neighboring node may receive the transmitted packet. A neighboring node is a node that is within the transmission range of the node transmitting the packet. If the neighboring node determines that a future hop on the route includes the neighboring node, the neighboring node may receive the packet at that time thereby skipping one or more hops along the route. The neighboring node may then forward the packet to the next node in the route that follows the neighboring node. The neighboring node may notify the originally destined node that the neighboring node has received the packet thereby avoiding a duplicate transmission of the packet to the neighboring node. If the neighboring node should receive the packet again, when transmitted along the original route, the neighboring node deletes the packet from its input queue.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary network utilizing skip-ahead routing.

FIG. 2 illustrates components of an exemplary system for skip-ahead routing in a wireless ad hoc network.

FIG. 3 is a flow diagram illustrating a first exemplary method for skip-ahead routing.

FIG. 4 is a block diagram illustrating a second exemplary method for skip-ahead routing.

### DETAILED DESCRIPTION

Various embodiments are directed to a mechanism for skip-ahead routing in a wireless ad hoc network. The technology described herein utilizes the broadcast nature of wireless ad hoc networks in which nodes within the transmission range of a transmitting node may be capable of receiving packets transmitted by the transmitting node. The transmission reception of each node may differ due to the direction of the power that the radio signals are radiated as well as other factors. Some nodes may utilize a directional antenna that may broadcast signals in a specified direction while other nodes may utilize an omni-directional antenna that broadcasts equally in all directions in a plane.

In some circumstances, a node may hear a broadcast of a transmission that is transmitted on a route that includes the node at a later hop. The node may receive the transmission earlier than intended and forward the transmission to the next hop in the route following the neighboring node. When the neighboring node receives the packet again, when transmitted along the original route, the neighboring node merely deletes the packet from its input queue.

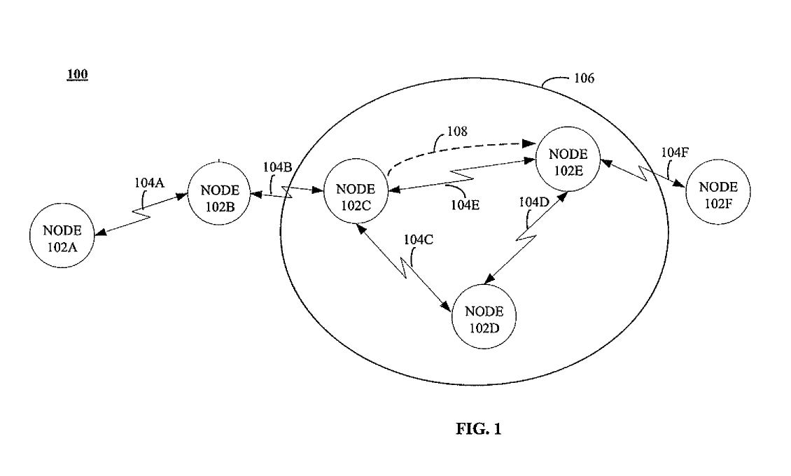

FIG. 1 illustrates an example of a wireless ad hoc network 100 utilizing skip-ahead routing. The network 100 may include a number of nodes 102A-102F communicatively coupled by wireless communication links 104A-104F. A route may consist of several hops starting from source node 102A to node 102B through link 104A, to node 102C through link 104B, to node 102D through link 104C, to node 102E through link 104D and to node 102F through 104F. Nodes 102C, 102D, and 102E are able to receive all packets transmitted within transmission range 106, regardless of whether or not the packet is destined for a node. Nodes 102C, 102D, and 102E may utilize one or more directional antennas, one or more omni-directional antennas, or any combination thereof to radiate the radio signals in multiple directions so that nodes 102C, 102D, and 102E receive transmissions within transmission range 106.

For example, as node 102C forwards a packet to node 102D on route to destination node 102F, node 102E may be capable of receiving the packet. Node 102E may receive the packet and determine whether or not the route that the packet is on will be forwarded to node 102E from node 102D after the packet arrives at node 102D. Node 102E may determine this from information in the packet header and routing information stored in node 102E's routing table. In this case, node 102E may receive the packet as it is transmitted from node 102C to node 102D, as shown in transmission path 108. Node 102E may then forward the packet to the next hop in the route which is node 102F. Meanwhile, node 102D receives the packet and may forward the packet to node 102E. When node 102E receives the packet again, node 102E recognizes that the packet is a duplicate and deletes the packet. Optionally, node 102E may also transmit a message to node 102D informing node 102D that node 102E has already received the packet. Alternatively, node 102D may hear the broadcasted transmission of the packet from node 102E to 102F and not forward the packet to 102E.

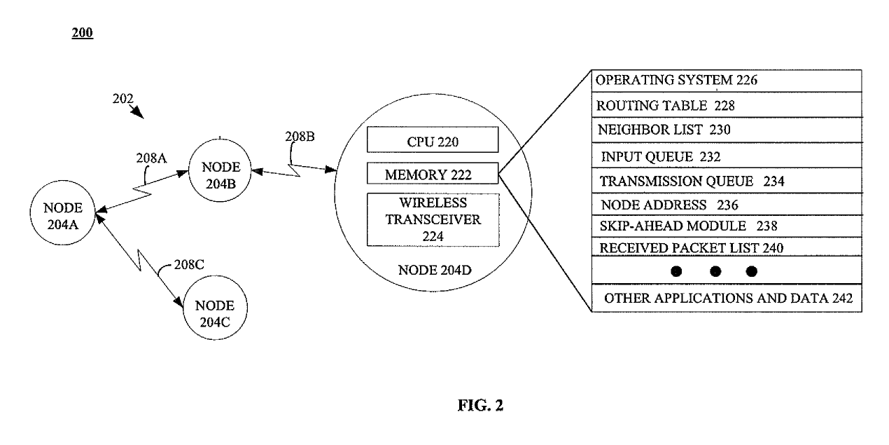

Attention now turns to a more detailed description of the components of an exemplary system embodying skip-ahead routing. FIG. 2 illustrates a block diagram of an exemplary system 200 for skip-ahead routing in a wireless ad hoc network. The system 200 may include a network 202 that includes several nodes 204A-D (collectively, 204) communicatively coupled by various wireless communication links 208A-C (collectively 208). Each node 204 may be any type of electronic device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, router, gateway, or any combination thereof. The communication links 208 facilitate communications between the nodes utilizing any type of wireless communication protocol that transmits signals via radio transmissions.

Each node may contain a processor or central processing unit (CPU) 220, a wireless transceiver 224, and a memory 222. The CPU 220 may be any commercially available processor and may include dual microprocessors and multi-processor architectures. The wireless transceiver 224 may be any electronic component that has the capability of receiving and transmitting radio frequency (RF) signals. The wireless transceiver 224 may be implemented in RF chips and/or chipsets, in a wireless transceiver module, or any combination thereof.

The memory 222 may be any computer-readable storage media that may store executable procedures, applications, and data. The computer-readable media does not pertain to propagated signals, such as modulated data signals transmitted through a carrier wave. It may be any type of memory device (e.g., random access memory, read-only memory, etc.), magnetic storage, volatile storage, non-volatile storage, optical storage, DVD, CD, floppy disk drive, and the like. The memory 222 may also include one or more external storage devices or remotely located storage devices.

The memory 222 may contain instructions and data as follows:
an operating system 226;
a routing table 228 that contains the routes and routing information of the network;
a neighbor list 230 that contains neighboring nodes that are one or two hops away;
an input queue 232 that contains packets received by the node;
a transmission queue 234 that contains packets awaiting transmission to another node;
a node address 236 that uniquely identifies the node;
a skip-ahead module 238 containing executable instructions capable of performing the skip-ahead routing;
received packet list 240 containing the packet identifiers of those packets the node has received; and
various other applications and data 242.

In an embodiment, the network 202 may be implemented as a wireless ad hoc network. A wireless ad hoc network is a self-configuring network that does not have an established infrastructure. There are various types of wireless ad hoc networks, such as without limitation, a mobile ad hoc network (MANET), and a mesh network. The embodiments described herein may utilize any of these types of networks or combination thereof.

Each node in a wireless ad hoc network acts as a router and monitors the network to maintain a list of the active routes in the network. A route is an ordered sequence of hops from a source node to a destination node. A hop is associated with a pair of nodes. The first node of the pair sends the packet to the second node of the pair which receives the packet. In some embodiments, a routing table and/or reachability database (collectively referred to herein as “routing table”) 228 may be used to store the routes and routing information in the network. The routing table 228 may be used by a transmitting node to determine the best route for a transmission. The routing table 228 may contain information on which set of nodes may be reached within a certain degree of accuracy, which set of nodes cannot be reached in a direct single hop, and the hops along a route. A transmitting node uses the information in the routing table 228 to select a particular route. The selection may be based on a routing objective, such as without limitation, the minimum number of hops, shortest distance between the sending or source node and the destination node, and so forth.

The primary means for communication in an ad hoc network is broadcasting. A broadcast is the process of transmitting a packet in a wireless ad hoc network so that nodes within the transmission range of the transmitting node may receive the transmission. The intended recipient of the transmission will receive the packet while the other nodes will not.

A routing protocol utilizes the information obtained in the routing table 228 to determine routes to destinations. A route may have at a minimum a destination address, a route identifier, and a route cost or metric. If there is more than one route, the routing protocol may determine which route may be used based on the source node's routing objective. If there is no route for a particular destination in the routing table 228, then a default route may be used.

In an embodiment, a pro-active routing protocol may be used. In a pro-active routing protocol, each node maintains the routes within the network in a routing table 228 and updates to the routes are periodically exchanged between nodes in order to maintain a consistent view. The updates may be contained in beacon messages or may be sent in a separate broadcast message. The routes are determined prior to a source node needing a route for a transmission. Examples of pro-active routing protocols include, without limitation, Destination Sequenced Distance Vector, the Wireless Routing Protocol, Source-Tree Adaptive Routing, Cluster-head Gateway Switch routing protocol, and any one or combination of these routing protocols may be used as the embodiments are not limited to any particular protocol.

In another embodiment, an on-demand routing protocol may be used. An on-demand protocol discovers a route when a source node needs to transmit to a destination. In this protocol, the node discovers a route that is more likely to be active and currently operational. A node floods the network with route discovery packets destined to a destination. A route reply packet is returned with a route from the source node to the destination node contained therein. Examples of on-demand routing protocols include, without limitation, Dynamic Source Routing protocol, the Ad Hoc On-Demand Distance Vector protocol, the Temporally Ordered Routing Algorithm, the Associativity Based Routing protocol, and any one or combination of these protocols may be used as the embodiments are not limited to any particular protocol.

Regardless of the type of routing protocol used, each node may utilize an input queue 232 to store transmissions received from a wireless communication link and a transmission queue 234 to store outgoing packets. The node address 236 may be any address that uniquely identifies the node from other nodes in the network, such as without limitation, an Internet Protocol (IP) address, a Media Access Control (MAC) address, and so forth.

A skip-ahead routing module 238 may be used to determine whether to receive a packet in advance of the order specified in a route. In an embodiment, the skip-ahead routing module 238 may be implemented as a software component. However, in other embodiments, the skip-ahead module 238 may be embodied in hardware, integrated as circuitry, or embodied as firmware in the wireless transceiver 224.

Although the system 200 shown in FIG. 2 has a limited number of elements in a certain configuration, it should be appreciated that the system 200 can include more or less elements in alternate configurations. In various embodiments, the system 200 described herein may comprise a computer-implemented system having multiple components, programs, procedures, modules. As used herein these terms are intended to refer to a computer-related entity, comprising either hardware, a combination of hardware and software, or software. For example, a component may be implemented as a process running on a processor, a hard disk drive, multiple storage drives (of optical and/or magnetic storage medium), an object, an executable, a thread of execution, a program, and/or a computer. By way of illustration, both an application running on a server and the server may be a component. One or more components may reside within a process and/or thread of execution, and a component may be localized on one computer and/or distributed between two or more computers as desired for a given implementation. The embodiments are not limited in this manner.

Operations for the embodiments may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

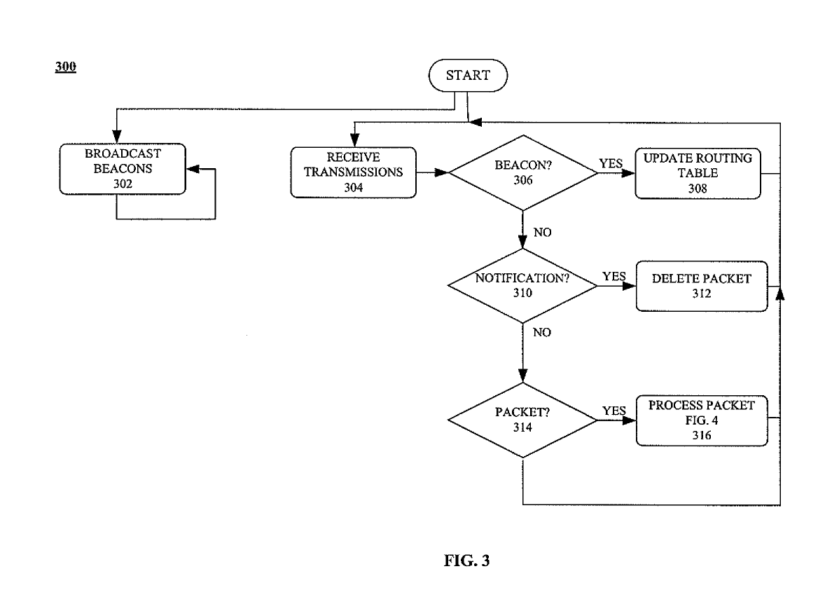

FIG. 3 illustrates a flow diagram of an exemplary method for skip-ahead routing in a wireless ad hoc network. It should be noted that the method 300 may be representative of some or all of the operations executed by one or more embodiments described herein and that the method can include more or less operations than that which is described in FIG. 3. In an embodiment, the method may be performed by the skip-ahead module 238.

In an embodiment, each node in the network may broadcast beacon messages announcing the node's existence, to discover the existence of other nodes within the transmission range, and to obtain current routing information from neighboring nodes (block 302). A beacon message may contain the broadcasting node's address and the beacon messages may be transmitted at regular intervals. The beacon message may be used as a means for a node to discover an ad hoc network that the node may join. Once the node joins the ad hoc network, the beacon messages may be used to determine active routes within the network.

Along with broadcasting beacon messages, each node in the network may receive transmissions and/or packets that the node hears within its transmission range. Each node may receive the packet and elect to receive the packet or delete it (block 304). The transmissions may be beacon messages from other nodes (block 306-yes), notifications that a packet skipped ahead to a next hop (block 306-no and block 310-yes), or packets broadcasted by the other nodes on route to a destination (block 310-no and block 314-yes).

When a beacon message is received (block 306-yes), the information in the beacon may be used to update the routing information in the routing table 228 (block 308). When a notification is received (block 310-yes), the duplicate packet may be deleted from the transmission queue 234 (block 312). A notification may be broadcasted to a skipped node so that the skipped node does not forward the packet to the neighboring node that has already received the packet.

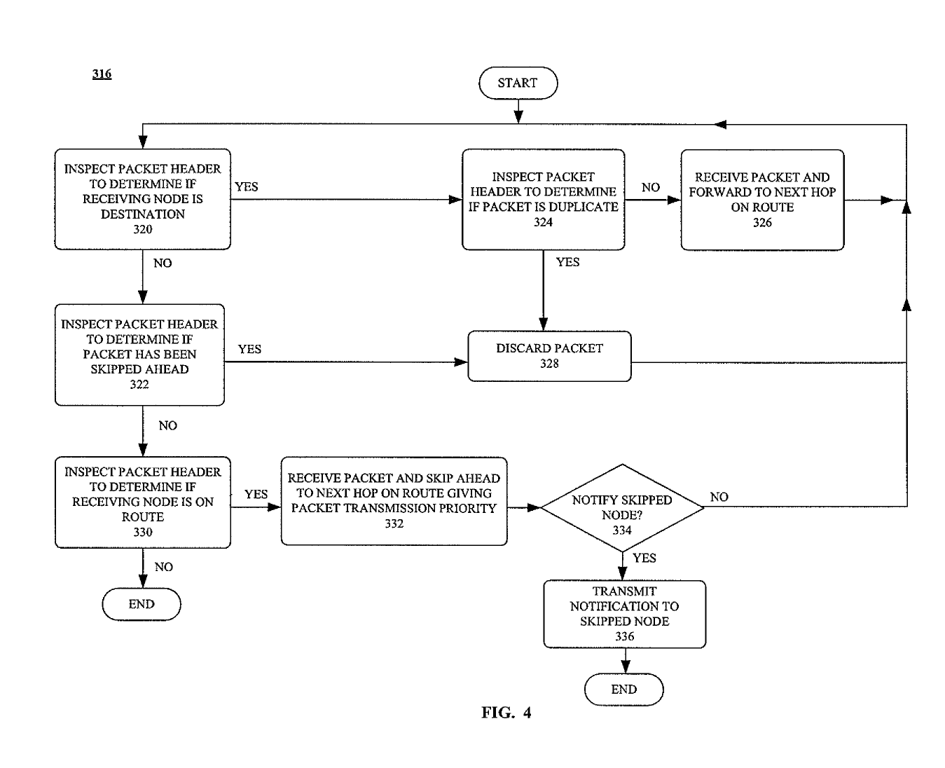

When a node receives a packet (block 314-yes), the skip-ahead routing module 238 may determine whether or not to receive the packet and the manner in which the packet should be processed (block 316). Turning to FIG. 4, the skip-ahead routing module 238 may inspect the packet header to determine if the packet was originally destined for the node receiving the packet (i.e., receiving node) (block 320). A packet header may include the destination address, a next hop address, a packet identifier, and a route identifier. If the destination address and/or next hop address is the node address of the receiving node, then the packet is intended for the receiving node (block 320-yes).

Next, the skip-ahead routing module 238 determines if the packet is a duplicate (block 324). A node may maintain a list of packet identifiers 240 that the node has received. The skip-ahead routing module 238 may check if the packet identifier of the current packet is on the list 240 thereby indicating that the packet is a duplicate (block 324-yes). The node may then discard the packet (block 328).

Otherwise, if the packet is not a duplicate (block 324-no), then the packet may be received by the node and placed in its transmission queue 234 for transmission to the next hop on the route (block 326). The next hop on the route may be in the packet header or determined from the route identifier in the packet header and the routing information in the routing table (block 326).

The skip-ahead routing module 238 may then inspect the packet header to determine if the broadcast message indicates that the packet is being skipped ahead to a further hop in the route (block 322). The skip-ahead routing module 238 may match the packet identifier in the packet header with the packet identifiers of the packets in its input queue and transmission queue. If there is a match (block 322-yes), then the packet is discarded (block 328). The packet may be in the input queue or the transmission queue depending on when the node receives the packet and in either case, the packet is removed from either queue and discarded (block 328).

If the packet was not broadcasted for transmission to the node (block 322-no), then the skip-ahead routing module 238 inspects the packet header to determine if the packet is on a route intended for the receiving node at a later hop (block 330). The skip-ahead routing module 238 may match the routing identifier from the packet header in the routing table to determine if the receiving node is on the same route (block 330). Alternatively, all the hops in the route may be already contained in the packet header and the skip-ahead routing module 238 may find its node address in the packet header (block 330).

If the receiving node is a further hop on the route (block 330-yes), then the node may receive the packet and place it in its input queue 232 to process for transmission to the next hop (block 332). In an embodiment, a transmission queuing protocol may place the skipped ahead packets at the head of the transmission queue 234. This may be done in order to ensure that the skipped ahead packets are transmitted to the next hop prior to the skipped node transmitting the same packet to the next hop, which may be the receiving node. In this manner, the skipped node may receive the notification message prior to forwarding the packet to the next hop.

In some situations, the skip-ahead routing module 238 may transmit a notification to the skipped node (block 334-yes). The notification may be a short message or signal so that the skipped node receives the notification before the skipped node forwards the packet to the next hop which has already received the packet (block 336). Otherwise (block 334-no), the skip-ahead routing module 238 continues to process the next transmission.

The embodiments described herein are focused on improving the performance of an ad hoc network by combining an established route together with the capability to skip ahead whenever physical channel conditions, such as the transmission reception, permit it. The technique does not alter existing routes rather takes advantage of the transmission reception amongst the nodes in a network to allow a packet to advance one or more hops. As the link reception and conditions may be temporal in nature, the technique does not alter an existing route. In this manner, the technique lowers the end-to-end packet latency and has the potential for higher network throughput.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

What is claimed:

1. A computer-implemented method, comprising:
providing a plurality of routes in a wireless ad hoc network, at least one route having an ordered sequence of hops, each hop is associated with a pair of nodes on the route;
receiving, at a neighboring node, a packet transmitted from a first node to a second node during transmission of the packet from the first node to the second node, the neighboring node being a node on the route after the second node; and
forwarding, by the neighboring node, the packet to a third node, the third node being a node on the route after the neighboring node.

2. The computer-implemented method of claim 1, further comprising:
receiving, at the neighboring node, the packet forwarded from the second node to the neighboring node; and
deleting the packet at the neighboring node.

3. The computer-implemented method of claim 1, wherein the packet is given a higher priority in transmission when forwarded to the third node.

4. The computer-implemented method of claim 1, further comprising:
transmitting, by the neighboring node, a notification to the second node that the neighboring node has already received the packet.

5. The computer-implemented method of claim 4, further comprising:
eliminating, by the second node, transmission of the packet to the neighboring node.

6. The computer-implemented method of claim 1, wherein the third node is the next node on the route after the neighboring node.

7. The computer-implemented method of claim 1, further comprising:
receiving, at the second node, a transmission forwarding the packet from the neighboring node to the third node; and
thwarting, at the second node, forwarding the packet to the neighboring node.

8. The computer-implemented method of claim 1, further comprising:
receiving, at the third node, the packet; and
forwarding the packet to the next node in the route.

9. A non-transitory computer-readable storage medium storing thereon processor-executable instructions, comprising:
a routing table containing a plurality of routes, each route having an ordered sequence of hops, each hop associated with a pair of nodes in a wireless ad hoc network; and
a skip-ahead routing module having processor-executable instructions that when executed enables a neighboring node to receive a packet during transmission of the packet from a first node to a second node which the neighboring node then forwards to a third node, the packet associated with a first route, the third node associated with a hop later in the first route than the neighboring node, the neighboring node associated with a hop later in the route than the second node and before the third node.

10. The non-transitory computer-readable storage medium of claim 9, wherein the third node is a next node in the first route after the neighboring node.

11. The non-transitory computer-readable storage medium of claim 9, wherein the skip-ahead routing module having further instructions that when executed enables the neighboring node to transmit the packet with a higher transmission priority than other transmissions.

12. The non-transitory computer-readable storage medium of claim 9, wherein the skip-ahead routing module having further instructions that when executed enables the neighboring node to notify the second node that the neighboring node received the packet.

13. The non-transitory computer-readable storage medium of claim 9, wherein the skip-ahead routing module having further instructions that when executed discards a received packet when having received the received packet, from another node.

14. The non-transitory computer-readable storage medium of claim 9, wherein the skip-ahead routing module having further instructions that when executed allows the second node to receive transmissions of the packet transmitted to the third node and to thwart forwarding the packet to the neighboring node.

15. The non-transitory computer-readable storage medium of claim 9, wherein the neighboring node is associated with a hop that is more than one hop away from the second node.

16. A network, comprising:
a plurality of nodes, each node coupled to a wireless communication link; and
a plurality of routes, each route having an ordered sequence of hops, each hop associated with a pair of nodes;
wherein a neighboring node is configured to receive a packet broadcast from a first node to a second node and to forward the packet to a third node, the packet having a route that includes the neighboring node as a node associated with a hop along the route after the second node and the third node as a node associated with a hop along the route after the neighboring node.

17. The network of claim 16, wherein the neighboring node is configured to notify the second node that the neighboring node has received the packet prior to the second node sending the packet to the neighboring node.

18. The network of claim 16, wherein the neighboring node is configured to not process the packet when transmitted by the second node.

19. The network of claim 16, wherein the neighboring node is a next hop on the route.

20. The network of claim 16, further comprising a fourth node, the fourth node configured to receive the packet broadcast from the neighboring node to the third node, the fourth node being a node associated with a hop along the route after the third node.
